(19) United States
(12) Patent Application Publication
(10) Pub. No.: US 2003/0096156 A1
(43) Pub. Date: May 22, 2003

(54) Electrode catalyzer for fuel cell, fuel cell air electrode employing electrode catalyzer, and catalytic activity evaluation method for electrode catalyzer

(75) Inventors: Takahiko Asaoka, Nagoya-shi (JP); Kazutaka Hiroshima, Aichi-gun (JP); Tatsuo Noritake, Nagoya-shi (JP); Yutaka Ohya, Nagoya-shi (JP); Hisao Kato, Nisshin-shi (JP); Tetsuo Nagami, Nagoya-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/290,229

(22) Filed: Nov. 8, 2002

(30) Foreign Application Priority Data
Nov. 20, 2001 (JP) 2001-354476

(51) Int. Cl. H01M 4/92; H01M 4/96

(52) U.S. Cl. 429/44; 429/13

(57) ABSTRACT

In a powder-form electrode catalyzer for a fuel cell which comprises catalyst particles that contain platinum, and an electrically conductive support supporting the catalyst particles, the ratio between a mean value D₁₁₁ of crystallite diameters of catalyst particles in a direction perpendicular to a (111) crystal face and a mean value D₁₀₀ of crystallite diameters of the catalyst particles in a direction perpendicular to a (100) crystal face is D₁₀₀/D₁₁₁<1, and a mean crystallite diameter of the catalyst particles is at most 5 nm. Due to a large surface area that functions as a catalyst and a great proportion of the catalyst particles that have (100) crystal faces present on surfaces, the electrode catalyzer has high oxygen reduction activity.

### INCORPORATION BY REFERENCE

The disclosure of Japanese Patent Application No.2001-354476 filed on Nov. 20, 2001, including the specification, drawings and abstract is incorporated herein by reference in its entirety.

### BACKGROUND OF THE INVENTION

1. Field of the Invention

The invention relates to an electrode catalyzer for a fuel cell, a fuel cell air electrode employing the electrode catalyzer, and a catalytic activity evaluation method for evaluating the oxygen reduction activity of the electrode catalyzer.

2. Description of the Related Art

Fuel cells, which convert chemical energy directly into electric energy utilizing electrochemical reactions of gases, achieve high power generation efficiency due to the freedom from Carnot efficiency constrains, and have very little adverse effect on environments due to clean gas emissions. Therefore, various uses of fuel cells are lately expected, for example, a use in electric power generation, a use as an electric power supply for low-pollution vehicles, etc. The fuel cells can be classified in accordance with the electrolytes employed. For example, a phosphoric acid fuel cell, a molten carbonate fuel cell, a solid oxide fuel cell, a polymer electrolyte fuel cell, etc. are known.

Generally, a fuel cell has, as an electricity generation unit, an electrode-electrolyte assembly (a membrane-electrode assembly) in which a fuel electrode and an air electrode are provided on two sides of an electrolyte, and generates electricity by supplying a fuel gas, such as hydrogen, hydrocarbons, etc., to the fuel electrode, and supplying oxygen or air to the air electrode, and thereby causing electrochemical reactions to progress on the three-phase interfaces between the gases, the electrolyte and the electrodes.

Often used as a catalyst for facilitating the progress of the aforementioned reactions on the fuel electrode and the air electrode is a catalyzer formed by loading an electrically conductive support of carbon or the like, with a noble metal such as platinum or the like. In order to enhance the activity of the catalyzer, it is conceivable to increase the amount of platinum supported as a catalyst component, increase the specific surface area of platinum, etc. To this end, various methods for supporting smaller-size platinum particles on a support at higher particle density without allowing aggregation of platinum particles have been proposed. These methods make it possible to provide a catalyzer loaded with fine platinum particles at high density.

### SUMMARY OF THE INVENTION

It is an object of the invention to provide an electrode catalyzer for use in a fuel cell in which catalyst particles are supported on an electrically conductive support, and which has great catalytic activity. It is another object of the invention to provide a fuel cell air electrode having high oxygen reduction activity by using the electrode catalyzer as a catalyst of the air electrode. It is still another object of the invention to provide a method for evaluating the catalytic activity of the electrode catalyzer through various measurements of the size of crystallites of catalyst particles in the electrode catalyzer.

A first aspect of the invention relates to an electrode catalyzer for a fuel cell. The electrode catalyzer for a fuel cell has catalyst particles that contain platinum, and an electrically conductive support supporting the catalyst particles.

In the first aspect of the invention, a ratio between a mean value D₁₁₁ of crystallite diameters of catalyst particles in a direction perpendicular to a (111) crystal face and a mean value D₁₀₀ of crystallite diameters of the catalyst particles in a direction perpendicular to a (100) crystal face is D₁₀₀/D₁₁₁<1, and a mean crystallite diameter of the catalyst particles is at most 5 nm. Platinum particles that form catalyst particles are formed by single crystals, that is, each platinum particle is a crystallite. With regard a cubic system, the crystallite configuration is known to vary depending on the sizes of crystallites. FIG. 1 indicates relationships between configurations and sizes of crystallites. There are various crystallite configurations, for example, from a configuration in which only (100) crystal faces are present on surfaces as shown in FIG. 1Ato a configuration in which only (111) crystal faces are present on surfaces as shown in FIG. 1D. That is, it is considered that the crystal configuration varies depending on the sizes of crystallites because the crystal faces that are likely to present on surfaces vary depending on the sizes of crystallites. Considered below will be a case where two kinds of sizes of a crystallite, that is, crystallite diameters, are measured in certain different measurement directions. It can be understood that the ratio between the two kinds of crystallite diameters will vary if the configuration varies. For example, a crystallite diameter d₁₁₁ of a crystallite having a certain configuration measured in a direction (an arrow h2 in FIG. 1D) perpendicular to a (111) crystal face, and a crystallite diameter d₁₀₀ of the crystallite measured in a direction (an arrow h1 in FIG. 1A) perpendicular to a (100) crystal face are compared. In a cubic crystal configuration shown in FIG. 1A, d₁₀₀/d₁₁₁=1/√3. In an octahedral crystal configuration, d₁₀₀/d₁₁₁=√3. In reality, most crystals are considered to have intermediate configurations as shown in FIGS. 1B and 1C, in which the value of d₁₀₀/d₁₁₁ also assumes intermediate values between the aforementioned values. That is, the value of d₁₀₀/d₁₁₁ serves as an indicator that indicates the crystal faces that are present on the surfaces of crystallites. That is, it can be said that the proportion of (100) crystal faces increases with decreases in the value of d₁₀₀/d₁₁₁, and the proportion of (111) crystal faces increases with increases in the value of d₁₀₀/d₁₁₁.

Normally, which crystal face is likely to present on the surfaces of a crystallite depends on the surface energy of the crystal face. In the case of a cubic-crystal platinum particle, a theoretical value of surface energy of the (111) crystal faces is 2.299 J/m², and a theoretical value of surface energy of the (100) crystal faces is 2.734 J/m². Therefore, (111) crystal surfaces, having less surface energy than (100) crystal faces, are more likely to present on surfaces. The present inventor has considered that if a platinum particle, that is, a crystallite, has a smaller size, the crystallite is more subject to surface energy, and therefore, if the size of a crystallite is smaller, the appearance proportion of (111) crystal faces having less surface energy becomes higher. If (111) crystal faces are present on surfaces of a crystallite in a higher proportion, the configuration of the crystallite is more similar to an octahedron. Correspondingly, the value of d₁₀₀/d₁₁₁ becomes relatively greater.

The oxygen reduction activity of platinum particles is known to vary depending on the crystal faces present on the surfaces of the particles. For example, in a sulfuric acid aqueous solution electrolyte, the oxygen reduction activity of a (100) crystal face is much higher than that of a (111) crystal face. Therefore, it is considered that if a crystallite is small in size but (111) crystal faces, having low oxygen reduction activity, are present in a high proportion on surfaces of the crystallite, the catalytic activity is not very high.

In the electrode catalyzer for a fuel cell of the invention, since the mean crystallite diameter of the catalyst particles is as small as or smaller than 5 nm, the surface area of each catalyst particle that serves as a catalyst is great. Therefore, the electrode catalyzer achieves high catalytic activity. Furthermore, since the ratio between a mean value D₁₁₁ of crystallite diameters of catalyst particles in a direction perpendicular to a (111) crystal face and a mean value D₁₀₀ of crystallite diameters of the catalyst particles in a direction perpendicular to a (100) crystal face is D₁₀₀/D₁₁₁<1, the proportion of the catalyst particles that have (100) crystal faces present on surfaces is great. Therefore, the electrode catalyzer achieves high oxygen reduction activity.

A second aspect of the invention relates to a fuel cell air electrode. The fuel cell air electrode includes a powder-form electrode catalyzer that has catalyst particles that contain platinum, and an electrically conductive support supporting the catalyst particles. In the second aspect of the invention, a ratio between a mean value D₁₁₁ of crystallite diameters of catalyst particles in a direction perpendicular to a (111) crystal face and a mean value D₁₀₀ of crystallite diameters of the catalyst particles in a direction perpendicular to a (100) crystal face is D₁₀₀/D₁₁₁<1, and a mean crystallite diameter of the catalyst particles is at most 5 nm. In short, the fuel cell air electrode is an air electrode that incorporates the above-described electrode catalyzer as a catalyst. The use of the electrode catalyzer increases the oxygen reduction activity, and realizes an air electrode that has a reduced overvoltage. As a result, it becomes possible to construct a high-output fuel cell. Furthermore, since the electrode catalyzer used in the air electrode has high catalytic activity, it is possible to achieve good cell performance while reducing the amount of catalyst used. Therefore, the air electrode allows reduction of the amount of catalyzer containing high-cost platinum that is used in the air electrode, and therefore can be provided at low cost.

A third aspect of the invention relates to a catalytic activity evaluation method for an electrode catalyzer. This evaluation method is a method for evaluating an oxygen reduction activity of a fuel cell electrode catalyzer in a powder form which has catalyst particles that contain platinum, and an electrically conductive support supporting the catalyst particles. In the third aspect of the invention, the oxygen reduction activity is evaluated based on a value of a ratio between a mean value D₁₁₁ of crystallite diameters of catalyst particles in a direction perpendicular to a (111) crystal face and a mean value D₁₀₀ of crystallite diameters of the catalyst particles in a direction perpendicular to a (100) crystal face, and a mean crystallite diameter of the catalyst particles. As discussed above, the oxygen reduction activity of the electrode catalyzer depends on the crystal faces appearing on surfaces of catalyst particles. The catalytic activity increases with decreases in the size of catalyst particles and with increases in the specific surface area of catalyst particles. Therefore, by measuring crystallite diameters of catalyst particles, a mean crystallite diameter thereof can be determined, and a degree of appearance of (100) crystal faces having high oxygen reduction activity on particle surfaces can be estimated. On the basis of these values, the oxygen reduction activity of the electrode catalyzer can be accurately and easily evaluated.

In the electrode catalyzer for a fuel cell in accordance with the first aspect of the invention, the mean crystallite diameter of the catalyst particles is as small as or smaller than 5 nm, and the ratio between a mean value D₁₁₁ of crystallite diameters of catalyst particles in a direction perpendicular to a (111) crystal face and a mean value D₁₀₀ of crystallite diameters of the catalyst particles in a direction perpendicular to a (100) crystal face is D₁₀₀/D₁₁₁<1. Therefore, in the catalyzer, the surface area of each catalyst particle that serves as a catalyst is great, and the proportion of the catalyst particles that have (100) crystal faces having oxygen reduction activity present on surfaces is great. That is, the electrode catalyzer achieves very high catalytic activity. The fuel cell air electrode in accordance with the second aspect of the invention is an air electrode that incorporates the above-described electrode catalyzer as a catalyst. Therefore, the air electrode realizes a low-cost air electrode that has a reduced overvoltage, and makes it possible to construct a high-output fuel cell. Furthermore, according to the catalytic activity evaluation method for an electrode catalyzer in the third aspect of the invention, a degree of appearance of (100) crystal faces having high oxygen reduction activity on particle surfaces can be estimated from the value of D₁₀₀/D₁₁₁. On the basis of the mean crystallite diameter and the value of D₁₀₀/D₁₁₁, the oxygen reduction activity of the electrode catalyzer can be accurately and easily evaluated.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIGS. 1A-1D indicate a relationship between the sizes and the configurations of crystallites of platinum;

FIG. 2 indicates relationships between the discharge current densities and the mean crystallite diameters of catalyst particles in #1 to #13 catalyzers;

FIG. 3 indicates relationships between the discharge current densities and the catalyst surface areas per electrode unit area in the #1 to #13 catalyzers;

FIG. 4 indicates relationships between the discharge current densities per catalyst surface area and the mean crystallite diameters of catalyst particles in the #1 to #13 catalyzers;

FIG. 5 indicates relationships between the mean crystallite diameters and the values of D₁₀₀/D₁₁₁ in the #1 to #17 catalyzers;

FIG. 6 indicates relationships between the discharge current densities per catalyst surface area and the values of D₁₀₀/D ₁₁₁ in the #1 to #17 catalyzers; and

FIG. 7 indicates relationships between the discharge current densities and the mean crystallite diameters of catalyst particles in the #1 to #17 catalyzers.

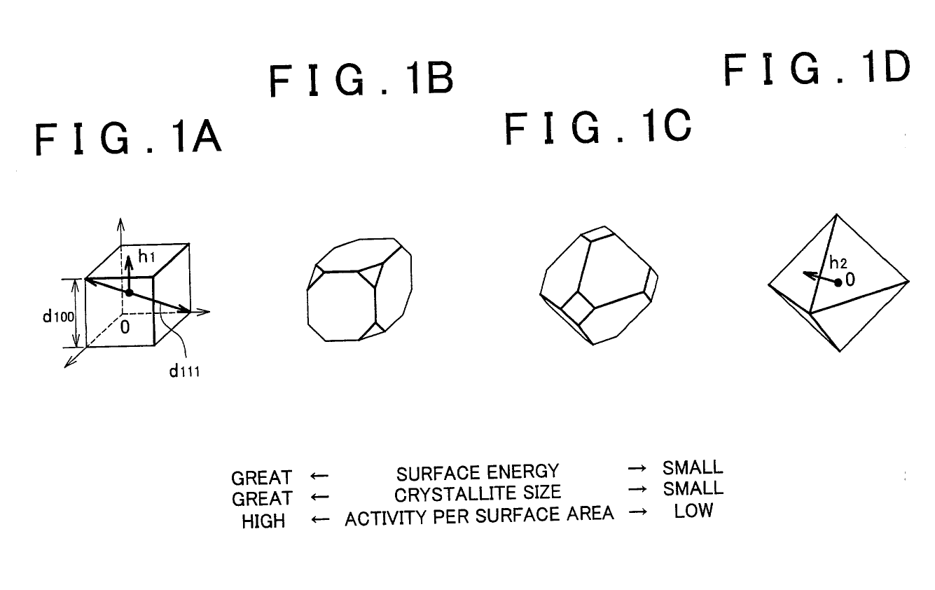

### DETAILED DESCRIPTION OF THE PREFERRED EMBODIMENTS

Through experiments, the present inventor has found that even if an electrode catalyzer incorporating reduced-size platinum particles for improved catalytic activity is used as an electrode catalyst of a fuel cell, it is not always the case that the catalytic activity is improved corresponding to the increase in the specific surface area of platinum particles. Normally, if the particle size of platinum particles as catalyst particles is reduced, the specific surface area of the particles increases, so that a corresponding increase in catalyst activity is expected. However, in the case of the aforementioned catalyzer, reduction of the particle size of platinum particles to a very small size did not significantly improve the catalytic activity of the catalyzer despite a correspondingly increased specific surface area.

Embodiments of the electrode catalyzer for a fuel cell, the fuel cell air electrode employing the electrode catalyzer, and the catalytic activity evaluation method for the electrode catalyzer of the invention will be described in detail separately for the electrode catalyzer, the air electrode, and the catalytic activity evaluation method. The embodiments described below are merely illustrative, and the electrode catalyzer, the fuel cell air electrode employing the electrode catalyzer, and the catalytic activity evaluation method for the electrode catalyzer of the invention are not limited to the embodiments. The invention may be carried out as in the below-described embodiments, and also in various other forms with modifications, improvements, etc. that are possible for those skilled in the art.

(1) Electrode Catalyzer

The electrode catalyzer for a fuel cell of the embodiment is in the form of powder made from catalyst particles that include platinum, and an electrically conductive support that supports the catalyst particles. The catalyst particles may be particles formed only of platinum, or may be particles that further contain a metal element other than platinum. For example, it is preferable that the particles be formed of an alloy of platinum and a metal that is less noble than platinum, in order to further improve the catalytic activity of platinum. As for the less noble metal, it is appropriate to use at least one species selected form the group consisting of, for example, Fe, Mn, Co, Ni and Cr. In particular, Fe and Mn are preferable as the less noble metal because they are abundant on the earth and are available at low cost, and have high effect of improving the catalytic activity. The less noble metal content in the catalyst particles is not particularly limited. However, it is preferable that the less noble metal content be equal to or more than 5%, and less than or equal to 50% where the total number of platinum and less noble metal atoms is defined as 100%. If the less noble metal content is less than 5%, the activity improving effect by alloying is little. If the less noble metal content exceeds 50%, the amount of less noble metal that can not dissolve in platinum increases. In particular, if the activity improvement achieved by alloying is considered, the less noble metal content is preferably 10% or more.

The electrode catalyzer of the embodiment is formed from catalyst particles and an electrically conductive support. The content of platinum in the catalyst particles in the entire electrode catalyzer is not particularly limited. A preferable platinum content is equal to or greater than 10 wt. %, and less than or equal to 60 wt. % where the total weight of the electrode catalyzer (if the electrically conductive support is formed of carbon) is defined as 100 wt. %. If the platinum content in the entire catalyzer is less than 10 wt. %, the function of platinum as a catalyst cannot be sufficiently performed, so that electrode reactions do not readily progress. If the platinum content exceeds 60 wt. %, platinum aggregates so that the surface area of platinum that functions as a catalyst inconveniently reduces. The thickness of a catalyst layer in the electrode is formed with reference to the amount of platinum contained in the electrode catalyzer. Therefore, in view of an appropriate thickness of the catalyst layer formed with consideration of diffusion of oxygen, it is preferable that the platinum content be greater than or equal to 20 wt. %. Furthermore, in view of uniform formation of the catalyst layer, it is preferable that the platinum content be less than or equal to 40 wt. %.

The electrode catalyzer of the embodiment is formed by supporting the aforementioned catalyst particles on an electrically conductive support. The electrically conductive support is not particularly limited. For example, it is appropriate to use a carbon material, such as carbon black, graphite, carbon fiber, etc., because such carbon materials are good in electric conductivity, and are inexpensive. It is preferable that the electrically conductive support be in the form of powder due to large surface area per unit weight. In this case, it is preferable that the size of particles of the electrically conductive support be greater than or equal to 0.03 μm, and less than or equal to 0.1 μm. It is also preferable that the electrically conductive support particles form a structure of linked primary particles.

Furthermore, in the electrode catalyzer of the embodiment, the ratio between the mean value D₁₁₁ of crystallite diameters of catalyst particles in a direction perpendicular to a (111) crystal face and the mean value D₁₀₀ of crystallite diameters of the catalyst particles in a direction perpendicular to a (100) crystal face is D₁₀₀/D₁₁₁<1, and the mean crystallite diameter of the catalyst particles is equal to or less than 5 nm. If D₁₀₀/D₁₁₁<1, that is, if D₁₀₀<D₁₁₁, the proportion of catalyst particles in which (100) crystal faces are present on surfaces in a greater proportion, and therefore the electrode catalyzer has high catalytic activity, as described above. The values D₁₀₀, D₁₁₁ can be obtained by an analysis through powder X-ray diffractometry using CuKα ray. That is, the electrode catalyzer in a powder form is analyzed by powder X-ray diffractometry. From the thus-obtained diffraction pattern, a half-value width Bₖₗₘ (radian) of a diffraction peak of each crystal face (klm) is determined. Then, a mean value Dₖₗₘ (Å) of crystallite diameters of catalyst particles in a direction perpendicular to a (klm) crystal face is computed from Schuller's equation: Dₖₗₘ=Kλ/Bₖₗₘcosθₖₗₘ. In the equation, the constant K is 0.89, and λ is the wavelength of X ray (Å), and θₖₗₘ is the diffraction angel (°). The value D₁₀₀ is equivalent to a mean value D₂₀₀ of crystallite diameters in a direction perpendicular to a (200) crystal face of a double period, and therefore can be substituted with D₂₀₀.

The mean crystallite diameter of the catalyst particles is less than or equal to 5 nm, in view of increasing the surface area that contributes to reactions, and enhancing the catalytic activity. It is preferable that the mean crystallite diameter be less than or equal to 3 nm in order to further enhance the catalytic activity. The method for determining the mean crystallite diameter is not particularly limited. For example, the mean crystallite diameter can be determined by power X-ray diffractometry, and can also be determined through the use of a transmission electron microscope (TEM). For example, the electrode catalyzer is observed by a TEM, and maximum and minimum crystallite diameters of a distinguishable catalyst particle are measured. Then, a mean value of the measured maximum and minimum diameters is regarded as a crystallite diameter of the catalyst particle. A value obtained by averaging the crystallite diameters of individual catalyst particles observed is determined as a mean crystallite diameter. In this specification, a value determined by the aforementioned TEM observation method is adopted as a mean crystallite diameter.

The method for producing the electrode catalyzer of the invention is not particularly limited. In order to support platinum as catalyst particles on the electrically conductive support, it is appropriate to adopt, for example, a method in which a predetermined amount of a powder-form electrically conductive support is added into an aqueous solution containing a platinum-sulfurous acid complex, and a hydrogen peroxide solution is added, and the mixed solution is heated to a predetermined temperature. In order to achieve a desired platinum content in the electrode catalyzer, it is appropriate to suitably adjust the concentration of an aqueous solution containing a platinum-sulfurous acid complex and the amount of the electrically conductive support added. It is also appropriate to perform a reduction treatment using hydrogen, or a heat treatment in an inert gas atmosphere, after supporting the catalyst particles on the electrically conductive support by the aforementioned method. If the reduction treatment or the heat treatment is performed, it is appropriate to suitably adjust the conditions and the like so that a desired crystallite diameter of the catalyst particles is obtained.

In order to provide catalyst particles in which platinum and a metal that is less noble than platinum are alloyed, it is appropriate to adopt a method in which platinum and a metal that is less noble than platinum are supported on an electrically conductive support, and then are alloyed by heat treatment. That is, the electrically conductive support lodged with the platinum is dispersed in water, then a salt including the less noble metal as positive ion is added into the dispersion liquid, and a pH value of the aqueous solution is adjusted to a predetermined value, finally the aqueous solution is stirred. Accordingly, the less noble metal is dodged with the electrically conductive support in addition to the platinum. In order to achieve a target content of a less noble metal in the catalyst particles, it is appropriate to suitably adjust the concentration of a salt aqueous solution containing the less noble metal as positive ions. Then, the electrically conductive support supporting the two metals is subjected to a heat treatment for alloying after being subjected to filtration, drying, etc. The heat treatment may be performed by a method that is typically employed for alloying. For example, it is appropriate to keep the electrically conductive support loaded with platinum and a metal less noble than platinum, at a temperature of about 900-1000° C. for about 2 hours in an inert atmosphere. Due to this heat treatment, platinum and the less noble metal supported on the electrically conductive support are alloyed, thus forming catalyst particles.

(2) Air Electrode

The air electrode for a fuel cell in this embodiment is an air electrode incorporating the electrode catalyzer of the foregoing embodiment. The air electrode may be produced by a normally employed method. For example, to produce an air electrode-electrolyte assembly (an air electrode is coupled to one of the two surfaces of an electrolyte membrane) for a polymer electrolyte fuel cell, an electrode catalyzer-containing catalyst layer is formed on a surface of the electrolyte membrane by dispersing the electrode catalyzer of the foregoing embodiment in a liquid containing a polymer that serves as an electrolyte, and applying the dispersion liquid to the electrolyte membrane, and drying the applied dispersion liquid. Then, a carbon cloth or the like is pressed to the surface of the catalyst layer, thereby forming an air electrode-electrolyte assembly.

(3) Catalytic Activity Evaluation Method

The catalytic activity evaluation method for the electrode catalyzer of the embodiment is a method for evaluating the oxygen reduction activity of the electrode catalyzer based on the value of the ratio between the mean value D₁₁₁ of crystallite diameters of catalyst particles in the electrode catalyzer measured in a direction perpendicular to a (111) crystal face and the mean value D₁₀₀ of crystallite diameters of the catalyst particles in a direction perpendicular to a (100) crystal face, and the mean crystallite diameter of the catalyst particles. The values D₁₀₀, D₁₁₁ of the catalyst particles are determined through powder X-ray diffractometry using CuKα ray, and the value of the ratio D₁₀₀/D₁₁₁ is calculated as described above. A mean crystallite diameter of the catalyst particles is also calculated as described above. On the basis of the value of D₁₀₀/D₁₁₁ and the magnitude of the mean crystallite diameter, the oxygen reduction activity of the electrode catalyzer is evaluated. The oxygen reduction activity of the electrode catalyzer increases with decreases in the value of D₁₀₀/D₁₁₁ and the mean crystallite diameter. In the case of the electrode catalyzer of the foregoing embodiment, D₁₀₀/D₁₁₁<1, and the mean crystallite diameter is less than or equal to 5 nm.

On the basis of the foregoing embodiments, 17 kinds of electrode catalyzers were produced. Using the produced electrode catalyzers, polymer electrolyte fuel cells were formed. The catalytic activities of the electrode catalyzers were evaluated by measuring the discharge current density of each fuel cell. Below described are the production of electrode catalyzers, the preparation of polymer electrolyte fuel cells, and the evaluation of catalytic activity.

Table 1 shows the compositions of catalyst particles in the 17 kinds of electrode catalyzers produced, together with the mean crystallite diameters (nm) and the discharge current densities (mA/cm²) thereof.

<Production of Electrode Catalyzer>

The various electrode catalyzers were produced by using, as electrically conductive supports, three kinds of carbon blacks varying in specific surface area. Firstly, electrode catalyzers incorporating platinum particles as catalyst particles were produced. First, 1.5 g of hexahydroxyplatinic acid was dispersed in 50 ml of water, and 100 ml of an aqueous solution of 6% sulfurous acid was added thereto. The mixed solution was then stirred for 1 hour. After that, the solution was heated to 120° C. to remove residual sulfurous acid, and then was cooled. Thus, an aqueous solution of platinum-sulfurous acid complex (4 g-Pt/l) was prepared. Subsequently, 3 g of carbon black was dispersed in water to provide a dispersion liquid. The aforementioned aqueous solution of platinum-sulfurous acid complex was added to the dispersion liquid so that the weight ratio between platinum and carbon black became 3:2. Then, an aqueous solution of 20% H₂O₂ was added to the dispersion liquid, and the mixture was heated to 120° C. to cause reactions. Thus, platinum was supported on a carbon black. The reaction mixture was filtered. The thus-separated solid was vacuum-dried, and was subsequently pulverized. The obtained powder was subjected to a reduction treatment by keeping the powder at 200° C. for 2 hours in a water vapor stream, whereby an electrode catalyzer having platinum supported on carbon (hereinafter, referred to as “Pt/C catalyzer”) was obtained. The Pt/C catalyzers produced as described above were named #1 to #3 catalyzers. The Pt/C catalyzers produced by a heat treatment of keeping the aforementioned powder at 900° C. for 2 hours in an argon atmosphere after the aforementioned reduction treatment were named #4 to #6 catalyzers. The specific surface areas of carbon blacks used were about 1000 m²/g for the #1 and #4 catalyzers, and about 250 m²/g for the #2 and #5 catalyzers, and about 140 m²/g for the #3 and #6 catalyzers.

Next, electrode catalyzers employing particles of an alloy of platinum and a metal less noble than platinum as catalyst particles were produced. The #1 to #3 catalyzers were separately dispersed in 5 g of distilled water, thus preparing 3 kinds of catalyzer dispersion liquids. An aqueous solution of iron nitrate was added to each catalyzer dispersion liquid so that the atom ratio between platinum and iron became 3:1. An ammonia aqueous solution was then added to each dispersion liquid to adjust the pH value to 10. Each dispersion liquid was stirred at room temperature for 3 hours, thereby loading the platinum-loaded carbon black with iron. The content of platinum in each catalyzer was 20 wt. %. The dispersion liquids were then filtered, and the thus-separated solids were vacuum-dried. Thus, 3 kinds of catalyzers in which platinum and iron were supported on carbon were obtained. These catalyzers were subjected to a heat treatment of keeping them at 900° C. for 2 hours in an argon stream, thereby producing catalyst particles in which platinum and iron were alloyed. In this manner, catalyzers in which carbon was loaded with platinum-iron alloy catalyst particles (hereinafter, referred to as “Pt—Fe/C catalyzer”) were obtained. The Fe—Pt/C catalyzers produced as described above were named #10 to #12 catalyzers. The catalyzer produced through a heat treatment at 1000° C. in a production process for the #12 catalyzer was named #13 catalyzer.

Other Pt/C catalyzers were produced substantially in the same manner as in the #10 to #12 catalyzers, except that the weight ratio between platinum and carbon black was changed to 1:4. These Pt/C catalyzers were named #7 to #9 catalyzers. Furthermore, 4 kinds of catalyzers were produced substantially in the same manner as in the #7 catalyzer, except that the less noble metal alloyed with platinum was changed to Mn, Co, Ni and Cr, respectively. The thus-produced catalyzers were named #14 to #17 catalyzers.

<Preparation of Polymer Electrolyte Fuel Cell>

Using the #1 to #17 catalyzers as air electrode catalysts, 17 kinds of polymer electrolyte fuel cells were prepared. As for the fuel electrode catalyst, the #1 catalyzer was used in all the fuel cells. Each catalyzer was separately mixed with an alcohol dispersion liquid of Nafion (registered trademark, by Dupont), that is, an electrolyte, to have a paste form, in such a manner that the weight of platinum for an electrode area of 1 cm² became equal to 0.3 mg in the air electrode, and 0.5 mg in the fuel electrode. Each paste was applied to two surfaces of a Nafion membrane (about 50 μm in membrane thickness) that was to form an electrolyte membrane, and the paste was then dried. In this manner, catalyst layers of the two electrodes were formed. Then, a carbon cloth to which a paste-form mixture of carbon black and Teflon (registered trademark, by Dupont) having water repellency had been applied was joined, as a diffusion layer, to a surface of the catalyst layer of each of the two electrodes, by hot press. Thus, an electrode-electrolyte assembly was formed. The thus-formed electrode-electrolyte assembly was sandwiched by carbon-made separators, so as to form a cell.

<Evaluation of Catalytic Activity>

With respect to the 17 kinds of cells produced as described above, the catalytic activities of the electrode catalyzers employed were evaluated by measuring the discharge current densities. Each polymer electrolyte fuel cell was operated at an operation temperature of 80° C. by supplying the fuel electrode with humidified hydrogen having a dew point of 90° C. and supplying the air electrode with humidified air having a dew point of 70° C. Hydrogen was supplied at a rate of 50 ml/(min·cm²) under a pressure of 0.2 MPa. Air was suplied at a rate of 100 ml/(min·cm²) under 0.2 Mpa. The discharge characteristic exhibited as a cell characteristic involves not only the catalyst activity, but also other factors, such as the electric conduction within the cell, the mass transfer of reaction species, etc., and is therefore complicated. Herein, the catalytic activities of the catalyzers were studied by comparing low-current densities where the effect of catalytic activity appears in greater magnitude, that is, the discharge current densities (hereinafter, indicated by “I_{0.85V}”) exhibited when the voltage was set at 0.85 V.

TABLE 1

| | | Mean crystallite | Discharge current |
|---|---|---|---|
| Catalyer | Catalyst particle | diameter | density |
| No. | composition | (nm) | (mA/cm²) |
| #1 | Pt | 1.5 | 140.8 |
| #2 | Pt | 2.0 | 135.2 |
| #3 | Pt | 3.5 | 115.9 |
| #4 | Pt | 4.8 | 98.6 |
| #5 | Pt | 7.3 | 72.9 |
| #6 | Pt | 8.5 | 68.5 |
| #7 | Pt-Fe | 2.2 | 211.3 |
| #8 | Pt-Fe | 3.2 | 153.2 |
| #9 | Pt-Fe | 4.1 | 123.7 |
| #10 | Pt-Fe | 4.9 | 110.4 |
| #11 | Pt-Fe | 6.2 | 92.7 |
| #12 | Pt-Fe | 7.5 | 82.3 |
| #13 | Pt-Fe | 9.0 | 71.4 |
| #14 | Pt-Mn | 2.3 | 198.4 |
| #15 | Pt-Co | 1.9 | 235.7 |
| #16 | Pt-Ni | 2.2 | 199.7 |
| #17 | Pt-Cr | 2.0 | 223.9 |

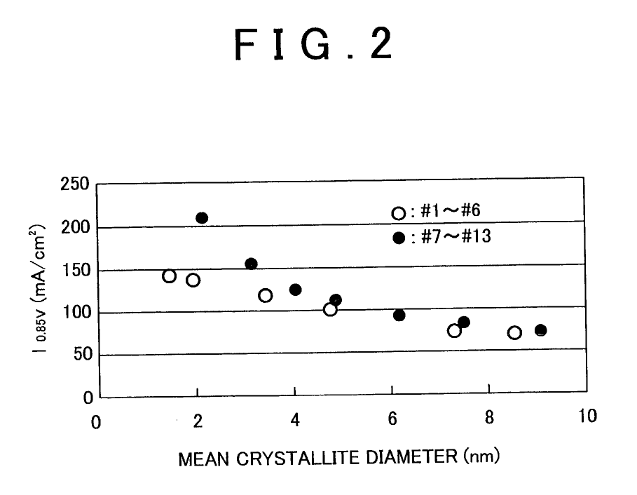

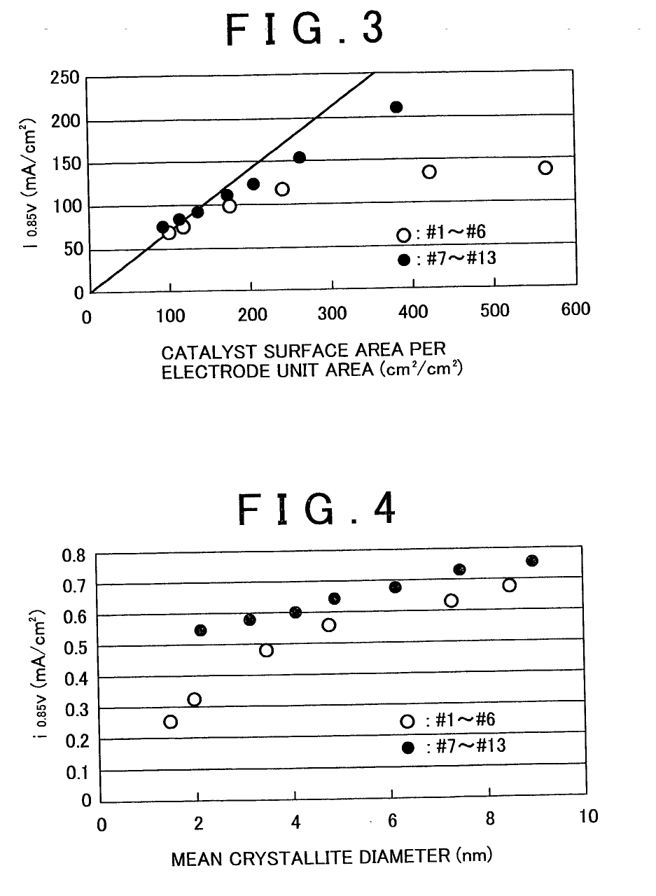

As shown in Table 1, the mean crystallite diameters of catalyst particles of the electrode catalyzers range from 1.5 to 9.0 nm, depending on the catalyst particle compositions, the carbon black surface areas, the conditions of production including heat treatments, etc. Relationships between the discharge current density I_{0.85V} and the mean crystallite diameter of catalyst particles of the #1 to #13 catalyzers are indicated in FIG. 2. In FIG. 2, symbol “◯” indicates values regarding the #1 to #6 catalyzers whose catalyst particles are only platinum particles, and symbol “●” indicates values regarding the #7 to #13 catalyzers whose catalyst particles are platinum-iron alloy particles (the same symbol indications are adopted in FIGS. 3 to 6). From FIG. 2, it can be understood that the discharge current density increases and the oxygen reduction activity of the catalyzer increases with decreases in the mean crystallite diameter, although the tendency varies depending on the catalyst particle compositions. However, it should be noted that the #1 to #3 catalyzers did not exhibit highly increased discharged current densities despite their mean crystallite diameters being less than 5 nm.

Relationships between the discharge current density I_{0.85V} and the catalyst surface area per electrode unit area are indicated in FIG. 3. The catalyst surface area per electrode unit area is a value calculated as follows. That is, on the assumption that the catalyst particles have a spherical shape, the surface area and the volume of a catalyst particle are determined from the mean crystallite diameter. Then, the weight of a catalyst particle is determined from the calculated volume thereof and the specific weight of platinum. Then, from the weight of platinum for an electrode area of 1 cm² as well, the number of catalyst particles contained in the area is determined. The multiplication product of the number of catalyst particles and the surface area of a catalyst particle is determined as a catalyst surface area per electrode unit area (hereinafter, simply referred to as “catalyst surface area”). From FIG. 3, it can be understood that the discharge current density increases with increases in the catalyst surface area. However, it should be noted that the #1 to #3 catalyzers, of which the mean crystallite diameters are less than 5 nm and the catalyst surface areas are larger than or equal to 250 cm²/cm², did not have such great discharge current densities as are expected from their large catalyst surface areas. That is, it has been found that, in a range where the catalyst surface area is great, that is, where the mean crystallite diameter of catalyst particles is small, the catalytic activity is not so improved as is expected from the large surface area. Furthermore, on the basis of the catalyst surface area determined from the mean crystallite diameter of catalyst particles, the discharge current density per catalyst surface area (hereinafter, referred to as “true discharge current density”, and indicated by “i_{0.85V}”) was calculated. FIG. 4 indicates relationships between the true discharge current density and the mean crystallite diameters of catalyst particles. From FIG. 4, it can be understood that the #1 to #3 catalyzers, whose mean crystallite diameters are less than 5 nm, exhibited considerably reduced discharge current densities per catalyst surface area, compared with the other catalyzers.

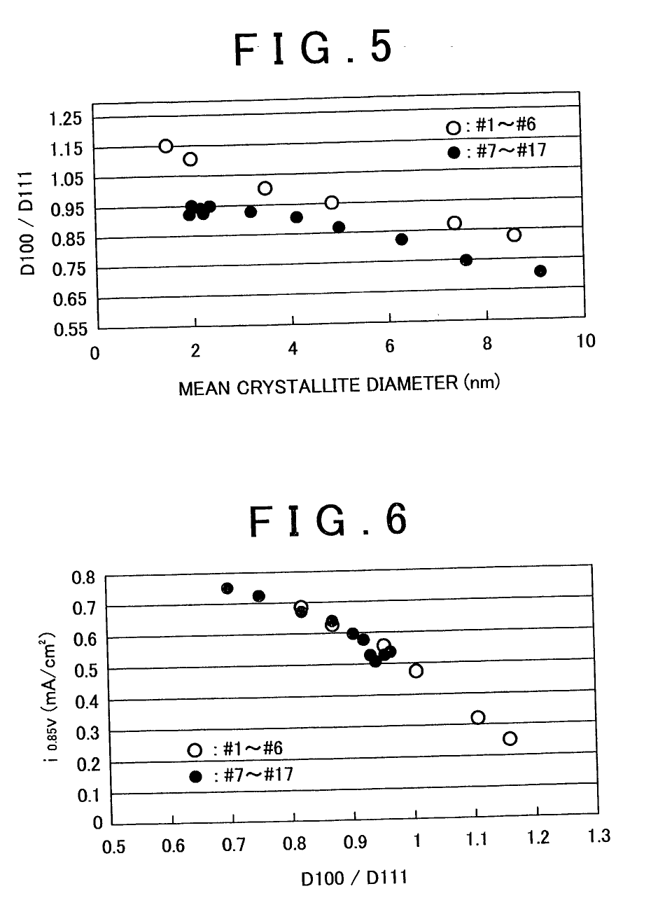

The #1 to #17 powder-form catalyzers were analyzed by powder X-ray diffractometry. From the obtained diffraction pattern of each catalyzer, a mean value D₁₁₁ of crystallite diameters of catalyst particles in a direction perpendicular to a (111) crystal face and a mean value D₁₀₀ of crystallite diameters of the catalyst particles in a direction perpendicular to a (100) crystal face were determined. The value D₁₀₀/D₁₁₁ of the ratio between the mean values of each catalyzer was calculated. Then, relationships between the values D₁₀₀/D₁₁₁ and the mean crystallite diameters of catalyst particles were investigated. Results are shown in FIG. 5. In FIG. 5, the #14 to #17 catalyzers employing Mn, Co, Ni and Cr as a metal alloyed with platinum are also indicated by symbol “●” (which indicates the same in FIG. 6). From FIG. 5, it can be understood that the value D₁₀₀/D₁₁₁ tends to increase with decreases in the mean crystallite diameter of catalyst particles. In particular, the values D₁₀₀/D₁₁₁ of the #1 to #3 catalyzers were greater than or equal to 1. These results agree with the fact that in a range of small mean crystallite diameters, the #1 to #3 catalyzers did not exhibit such high catalytic activities as expected from their surface areas as indicated in FIGS. 2 to 4. That is, it is considered that the catalytic activity of the #1 to #3 catalyzers did not greatly improve despite the small mean crystallite diameters, because the values D₁₀₀/D₁₁₁ of catalyst particles of the catalyzers were greater than or equal to 1 and the proportions of the (100) crystal faces present on surfaces were small. Furthermore, the catalyzers (indicated by symbol “●”) each having particles of an alloy of platinum and a less noble metal had relatively small values of D₁₀₀/D₁₁₁, compared with the catalyzers (symbol “◯”) having only platinum particles. The increase in the value of D₁₀₀/D₁₁₁ was reduced particularly in a range of small mean crystallite diameters of catalyst particles. This can be said regardless of the kinds of less noble metal used for alloying. That is, it has been found that adoption of alloyed catalyst particles reduces the decrease in the proportion of the (100) crystal face present on surfaces, even in the case where the catalyst particles are small.

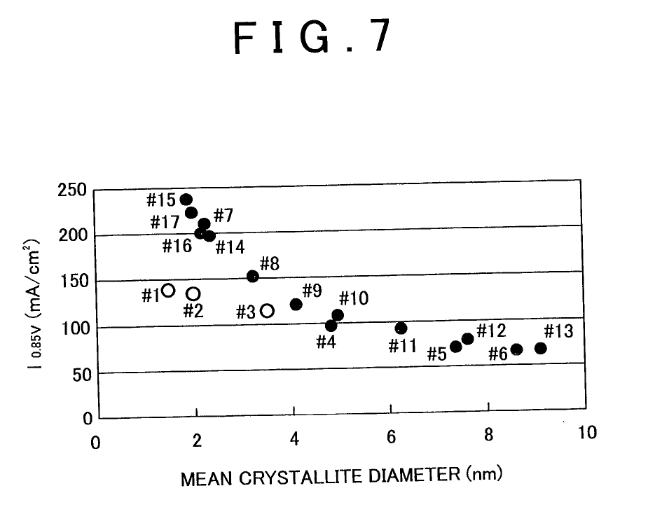

FIG. 6 indicates relationships between the true discharge current densities i_{0.85V} and the values of D₁₀₀/D₁₁₁ of the #1 to #17 catalyzers. From FIG. 6, it can be understood that there is a correlation between the values of D₁₀₀/D₁₁₁ and the true discharge current densities of the catalyzers, and the true discharge current density increases, that is, the catalytic activity increases, with decreases in the value of D₁₀₀/D₁₁₁. A conceivable reason for this result is that if the value D₁₀₀/D₁₁₁ is small, (100) crystal faces, having high catalytic activity, appear on surface in an increased proportion. FIG. 7 indicates relationships between the discharge current densities I_{0.85V} and the mean crystallite diameters of catalyst particles of the #1 to # 17 catalyzers, similar to FIG. 2, in view of whether the value D₁₀₀/D₁₁₁ is less than 1. In FIG. 7, symbol “◯” indicates catalyzers having catalyst particles with the value D₁₀₀/D₁₁₁ being greater than or equal to 1, and symbol “●” indicates catalyzers having catalyst particles with the value D₁₀₀/D₁₁₁ being less than 1. From FIG. 7, it can be understood that the catalyzers with the mean crystallite diameter being less than 5 nm and the value D₁₀₀/D₁₁₁ being less than 1 exhibited high discharge current densities and high oxygen reduction catalytic activities. Specifically, the aforementioned catalyzers are the catalyzers of #4, and #7 to #10, and #14 to #17, and are included within the scope of the electrode catalyzer of the invention. An air electrode incorporating such an electrode catalyzer is inexpensive, and achieves high catalytic activity, and therefore allows formation of a high-output fuel cell. Furthermore, it has been verified that the oxygen reduction activity of an electrode catalyzer can be evaluated on the basis of the value D₁₀₀/D₁₁₁ and the mean crystallite diameter of catalyst particles of the electrode catalyzer.

While the invention has been described with reference to what are presently considered to be preferred embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, less or only a single embodiment, are also within the spirit and scope of the invention.

What is claimed is:

1. An electrode catalyzer in a powder form for a fuel cell, comprising:
catalyst particles that contain platinum, a ratio between a mean value D₁₁₁ of crystallite diameters of the catalyst particles in a direction perpendicular to a (111) crystal face and a mean value D₁₀₀ of crystallite diameters of the catalyst particles in a direction perpendicular to a (100) crystal face, the ration being smaller than 1, and a mean crystallite diameter of the catalyst particles being at most 5 nm; and
an electrically conductive support supporting the catalyst particles.

2. The catalyzer according to claim 1, wherein the catalyst particles further contain at least one element selected from the group consisting of Fe, Mn, Co, Ni and Cr.

3. The catalyzer according to claim 1, wherein the electrically conductive support is a carbon material.

4. A fuel cell air electrode comprising the catalyzer according to claim 1.

5. A catalytic activity evaluation method for evaluating an oxygen reduction activity of a fuel cell electrode catalyzer in a powder form comprising catalyst particles that contain platinum, and an electrically conductive support supporting the catalyst particles, the method comprising:
measuring a first mean value D₁₁₁ of crystallite diameters of catalyst particles in a direction perpendicular to a (111) crystal face and a second mean value D₁₀₀ of crystallite diameters of the catalyst particles in a direction perpendicular to a (100) crystal face;
measuring a mean crystallite diameter of the catalyst particles; and
evaluating the oxygen reduction activity of the catalyzer based on a value of a ratio between the first mean value and the second mean value, and the mean crystallite diameter of the catalyst particles.
